(19) United States
(12) Patent Application Publication
(10) Pub. No.: US 2014/0197010 A1
(43) Pub. Date: Jul. 17, 2014

(54) Automatic Conveyor Shutoff System

(71) Applicant: Unverferth Manufacturing Company, Inc., Kalida, OH (US)

(72) Inventors: John Garberson, Columbus Grove, OH (US); Brian James Peterson, Ottawa, OH (US)

(73) Assignee: Unverferth Manufacturing Company, Inc., Kalida, OH (US)

(21) Appl. No.: 14/161,594

(22) Filed: Jan. 22, 2014

Related U.S. Application Data
(63) Continuation of application No. 12/862,052, filed on Aug. 24, 2010, now abandoned.
Application No. 12/862,052 is a continuation-in-part of application No. 12/554,740, filed on Sep. 4, 2009.
Application No. 12/554,740 is a continuation-in-part of application No. 12/031,867, filed on Feb. 15, 2008, now Pat. No. 8,221,047.
(60) Provisional application No. 60/901,321, filed on Feb. 15, 2007.

(51) Int. Cl. B65G 43/00

(52) U.S. Cl. CPC B65G 43/00
USPC 198/347.1

(57) ABSTRACT

An automatic conveyor shutoff system for a farm implement, such as a grain cart or seed tender, includes a conveying device and a storage bin. The conveying device is configured to convey material into or from the storage bin. A weighing device measures the weight of the storage bin and outputs a signal representing the weight to a controller. The controller is configured to disable the conveying device when the weight reaches a preset limit.

### CROSS-REFERENCE TO RELATED APPLICATIONS

The present application is a continuation of U.S. patent application Ser. No. 12/862,052 filed Aug. 24, 2010, which is a continuation-in-part of U.S. patent application Ser. No. 12/554,740 filed Sep. 4, 2009, the entire disclosure of which is incorporated herein by reference, which was a continuation-in-part of U.S. patent application Ser. No. 12/031,867 filed Feb. 15, 2008, the entire disclosure of which is incorporated herein by reference, which claimed the benefit of priority to U.S. Provisional Application Ser. No. 60/901,321 filed on Feb. 15, 2007, the entire disclosure of which is incorporated herein by reference.

### FIELD OF THE INVENTION

The present invention relates generally to a control system for a grain or seed carrier. More particularly, the present invention relates to a control system for a conveyor that can turn on or off the conveyor based on the amount of material being conveyed.

### DESCRIPTION OF THE RELATED ART

Farm implements (e.g., seed tenders, weigh wagons, grain carts, etc.) utilize conveyor systems to move material. Current conveyor systems for moving grain, seed, etc. from farm implements require an operator to manually control the conveyor system. Conventionally, the operator turns ON the conveyor manually, then manually monitors the conveying of the material until a desired amount of material is moved. At this point, the operator manually disables or turns OFF the conveyor system.

Some implements utilize weight measuring devices (e.g., scales), which may be coupled with an indicator, for measuring and displaying the weight (or relative weight) of material in a bin of the farm implement. Scale indicators can include an alarm mechanism, such as a buzzer or light, to let an operator know when a desired weight has been met. Such scale indicators can include a batch system, or preset value, that can be used for repeating a set weight (e.g., the alarm could be triggered every hundred pounds).

Current systems require an operator to be present to monitor manually the alarm associated with the scale indicator and to manually control the conveyor system. However, such manual operation is highly susceptible to human error.

Thus, there is a need for a new and improved conveyor shutoff system that automatically turns off the conveyor when a desired weight has been achieved.

### SUMMARY OF THE INVENTION

According to an embodiment of the present invention, a system for automatically controlling the conveying of material from a conveying device for a farm implement is provided. The implement may include a storage bin configured to store a material and a conveying device for moving material from the bin. The conveying device may be an auger, belt conveyor or other conventional conveyor. The system further includes a scale configured to measure the weight of the material in the storage bin and/or the material being conveyed. A controller is coupled with and in communication with the scale. The controller is configured to disable conveying device when the weight of the material in the storage bin achieves a pre-set weight limit.

According to another embodiment of the present invention, the system for automatically controlling the conveying of material from a conveying device may include a user input device configured to allow a user to enter at least one weight limit. The preset weight limit can be set to the entered weight limit(s). According to another embodiment of the present invention, the system may include a user control switch configured to allow a user to manually activate and disable the conveying device.

According to another embodiment of the present invention, the weighing device may include a scale display indicator that displays the weight of the bin and outputs an alarm signal when the weight of the material in the storage bin reaches a present limit. The controller may be coupled with the scale display such that it receives the alarm signal and controls the conveyor in response to the alarm signal. According to another embodiment of the present invention, the controller is configured to disable the conveyor upon receiving the alarm signal from the scale indicator.

According to another embodiment of the present invention, the conveying device is a motor driven belt conveyor. According to another embodiment of the present invention, the storage bin can include a discharge and the conveying device input is positioned to receive material from the storage bin discharge. According to another embodiment of the present invention, the conveying device discharge is positioned over the storage bin.

According to another embodiment of the present invention, the system for automatically controlling the conveying of material from a conveying device can include a conveyor control valve electronically coupled to the controller and configured to receive a signal from the controller and disable the conveying device upon receiving the signal. According to another embodiment of the present invention, the conveyor control valve includes a throttle actuator.

According to an embodiment of the present invention, a method for controlling the amount of material output from a conveyor includes conveying material from a storage hopper and monitoring the weight of the storage hopper with an electronic scale. The method further includes providing one or more preset weight alarms and sending a signal, with the electronic scale, representing the weight of the storage hopper to a controller. The method also includes determining if the weight of the hopper meets or exceeds the present weight alarm and, with a controller, electronically controlling the conveyor to disable the conveyor when it is determined that the weight of the hopper meets the present weight alarm.

According to one embodiment, a control system is provided that ties together the scale indicator, the electric on/off of the conveying device, and an operator control switch. A programmable multi-switch was set up to perform this task. When the scale indicator reaches the set weight and sends a signal out, the multi-switch receives this signal and turns the conveying device off. To restart the conveying device, the operator is required to turn the operator control switch off and then back on. This will signal the multi-switch to restart the conveying device. The multi-switch sends a signal to the scale indicator to reset the indicator for the next weighing cycle, and the scale indicator will begin the next cycle. The operator control switch is also tied in such that it will turn the conveying device off at any time, and will allow it to be restarted. In addition, the multi-switch defaults to the off position, so that anytime power is lost, the conveying device turns off. This also means that at start up, the conveying device will always be off, and there is no chance of it being in mid-cycle.

The above and/or other aspects, features and/or advantages of various embodiments will be further appreciated in view of the following description in conjunction with the accompanying figures. Various embodiments can include or exclude different aspects, features, or advantages where applicable. In addition, various embodiments can combine one or more aspects, features, or advantages where applicable. The descriptions of the aspects, features, or advantages of a particular embodiment should not be construed as limiting any other embodiment of the claimed invention.

### BRIEF DESCRIPTION OF THE DRAWINGS

FIG. 1 is a basic schematic of an automatic conveyor shutoff system according to an embodiment of the present invention.

FIG. 2 is a perspective view of a seed carrier according to an embodiment of the present invention.

FIG. 3 is a perspective view of a seed carrier in an unloading position according to an embodiment of the present invention.

FIG. 4 is a perspective view of a seed carrier in a loading position according to an embodiment of the present invention.

FIG. 5 is a side view of a belt conveyor for the seed carrier according to an embodiment of the present invention.

FIG. 6 is a forward view of a conveyor belt wrapping around a roller according to an embodiment of the present invention.

FIG. 7 is a view of the conveyor hopper of a conveyor in an unloading position according to an embodiment of the present invention.

### DETAILED DESCRIPTION OF THE PREFERRED EMBODIMENTS

While the present invention may be embodied in many different forms, a number of illustrative embodiments are described herein with the understanding that the present disclosure is to be considered as providing examples of the principles of the invention and such examples are not intended to limit the invention to preferred embodiment described herein and/or illustrated herein.

In embodiments of the present invention, an automatic conveyor shutoff system is configured to monitor the quantity of material that has been discharged or loaded has been achieved and to shutoff automatically a conveyor when a specified quantity of material has been discharged or loaded has been achieved. The following includes non-limiting examples of an automatic conveyor control system according to embodiments of the present invention. It should be appreciated that the following examples are provided for illustration and the present invention is not intended to be limited to the embodiments described herein.

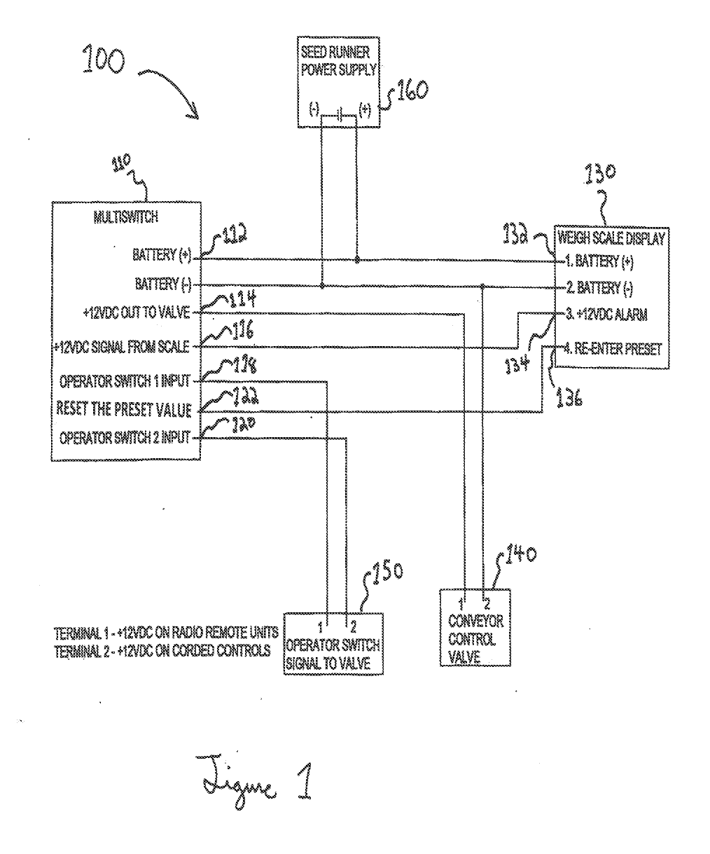

FIG. 1 is a basic schematic of a conveyor system 100 having a shutoff controller according to an embodiment of the present invention. The system 100 includes a multi-switch or control 110 coupled with a weigh scale display 130, a conveyor control valve 140 and an operator switch 150. The multi-switch 110 may include a battery 112, an electrical output 114, an electrical input 116, at least one operator switch input 118 and 120, and an output 122. In an embodiment of the present invention, the electrical output 114 of the multi-switch is electrically connected to the conveyor control valve 140. The weigh scale display 130 may include a battery 132, an electrical output 134, an input 136, and a display (not shown). In an embodiment of the present invention, the electrical output 134 of the weigh scale display 130 is electrically connected to the electrical input 116 of the multi-switch and the input 136 of the scale indicator is connected to the output 122 of the multi-switch. The conveyor control valve 140 may be an electric or hydraulic solenoid depending on the conveyor driver. In another embodiment of the present invention, the conveyor control valve 140 may be a high speed throttle actuator. In an embodiment of the present invention, the conveyor control valve 140 can be any electric on/off switch system.

The weigh scale display 130 may be configured to determine the weight of the material that has been loaded into or discharged from a conveying device from a weigh system (not shown). An exemplary system that could be employed with the present invention is disclosed in U.S. Pat. No. 7,205,490, the entire contents of which is incorporated herein by reference. When the amount of material that has been loaded into or discharged from the conveying device has achieved a preset weight limit, the electrical output 134 of the scale indicator sends a signal that is received by the electrical input 116 of the multi-switch. Upon receiving the signal, the multi-switch 110 controls the conveyor control valve 140—via the electrical output 114—to turn off the conveying device.

In an embodiment of the present invention, the weigh scale indicator 130 can include an input configured to allow a user to enter at least one preset limit into the scale indicator 130. In another embodiment of the present invention, the multi-switch 110 can be configured to enter a preset limit into the weigh scale indicator 130 by sending a signal from output 122 to input 136 of the scale indicator. Alternatively, a digital controller or processor could be employed to monitor the quantity of material that has been discharged or loaded directly.

In an embodiment of the present invention, the automatic conveyor shutoff system 100 includes an operator control switch 150. The operator control switch 150 is configured to allow a user to manually turn off the conveying device prior to weight achieving the preset limit. The operator control switch 150 may be a radio remote unit or corded controls. Further, the operator control switch 150 can be used to turn on the conveying device.

In an embodiment of the present invention, the weigh scale indicator 130 is configured to perform batch processing—a preset value can be used for repeating a set weight—in order to unload material in batches. After the conveying device has completed one cycle of loading or unloading material, a user can use the operator control switch 150 to signal the multi-switch 110 to repeat the cycle. The multi-switch 110 communicates with the scale indicator 130 by sending a signal from output 122 to input 136 of the scale indicator. The multi-switch 110 also controls the conveyor control valve 140 to turn on the conveying device.

In an embodiment of the present invention, the automatic conveyor shutoff system 100 includes a power supply 160. The power supply 160 can be an independent power supply for the automatic conveyor shutoff system 100 or it can be the power supply of the conveying device using the automatic conveyor shutoff system.

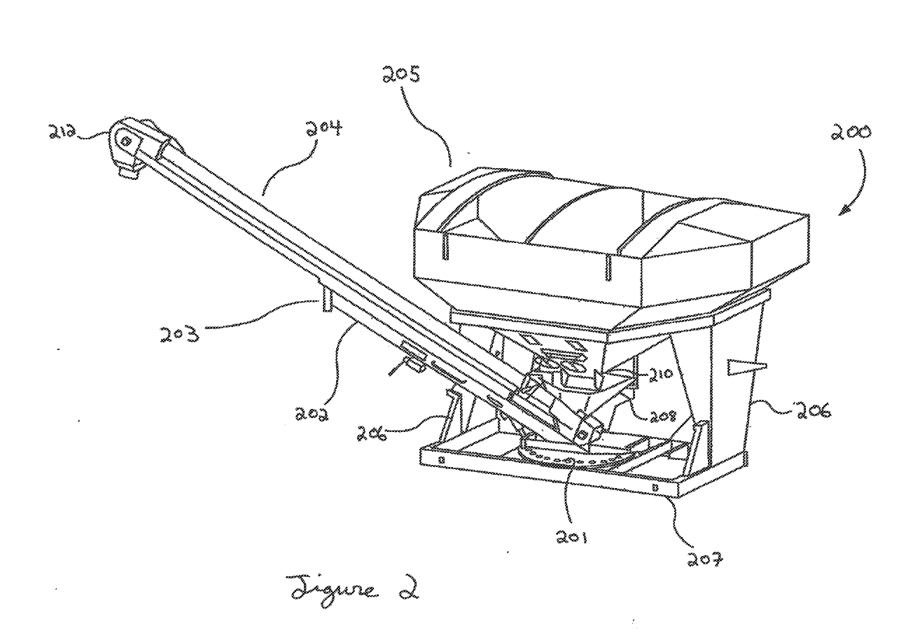

FIG. 2 is a diagram depicting a seed carrier having a tube conveyor according to an embodiment of the present invention. The seed carrier 200 is shown in an unloading position. The seed carrier 200 includes a storage bin or main hopper 205 coupled to a frame 207 by legs 206. In an embodiment of the present invention, the conveying device is a conveyor 204. The conveyor 204 can be supported by an assembly, such as one formed by support arm 202 coupled with a pivoting mechanism 201 fixed to the frame 207. The conveyor 204 may be pivotably coupled with the support arm by a coupling 203 at a point that is preferably near or at the center of gravity of the conveyor 204. The conveyor 204 may also be coupled to the support arm 202 by a latching mechanism at the bottom of the conveyor. The latch allows the conveyor 204 to be uncoupled from the support arm 202 at the bottom so that the conveyor is free to rotate about the coupling 203. By positioning the coupling 203 at or near the center of gravity of the conveyor 204, the conveyor 204 can balance on the pivoting coupling 203 such that little effort is required to rotate the conveyor 204.

The conveyor 204 may include a conveyor hopper 208 at its base, which is shown in the unloading position below the gravity discharge 210 of the main hopper 205. At the other end of the conveyor 204 is the discharge 212. Seed can be gravity feed from the main hopper 205 into the conveyor hopper 208, which can then be moved to the discharge 212 of the conveyor 204 by an internal elevator (not shown). In one embodiment, the elevator is a motor-driven belt type elevator coupled onto rollers at both ends of the conveyor. The belt of the elevator may be a flat belt, a crescent belt or a cleated belt. In an embodiment of the present invention, the motor-driven belt type elevator coupled onto rollers at both ends of the conveyor includes a centrifugal clutch. The conveyor 204 may be driven by a mechanical, hydraulic or electric means.

When the seed carrier 200 is in the unloading position, the automatic conveyor control system 100 can regulate the amount of material unloaded from the main hopper 205 by the conveyor 204. A weigh or scale system (not shown) measures the weight of a material stored in the main hopper 205 and provides data to the weigh scale indicator. When the weight of the material unloaded from the main hopper 205 achieves a preset limit, the scale indicator 130 sends a signal to the multi-switch 110. The multi-switch 110 then turns off the conveyor 204 via the conveyor control valve 140. In an embodiment of the present invention, the conveyor control valve 140 is a throttle actuator that causes the engine to idle and the centrifugal clutch of the conveyor to disengage. In an embodiment of the present invention, a user may turn the conveyor 204 back on using the operator control switch 150, and the conveyor 204 will unload material from the main hopper 205 until the next preset limit is achieved.

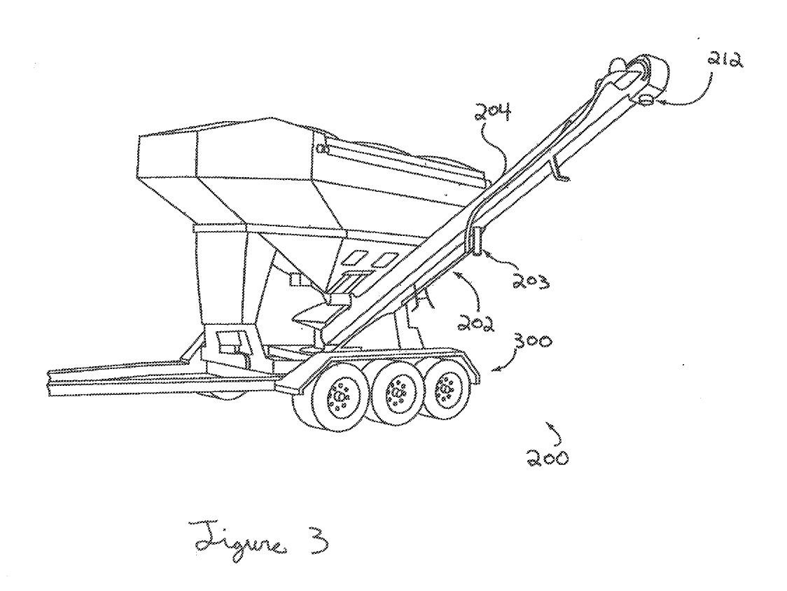

The seed carrier 200 may be transported by conventional means such as on a trailer. FIG. 3 illustrates the seed carrier 200 on a three axle trailer 300 according to an embodiment of the present invention. As shown, the conveyor 204 is in the unloading position.

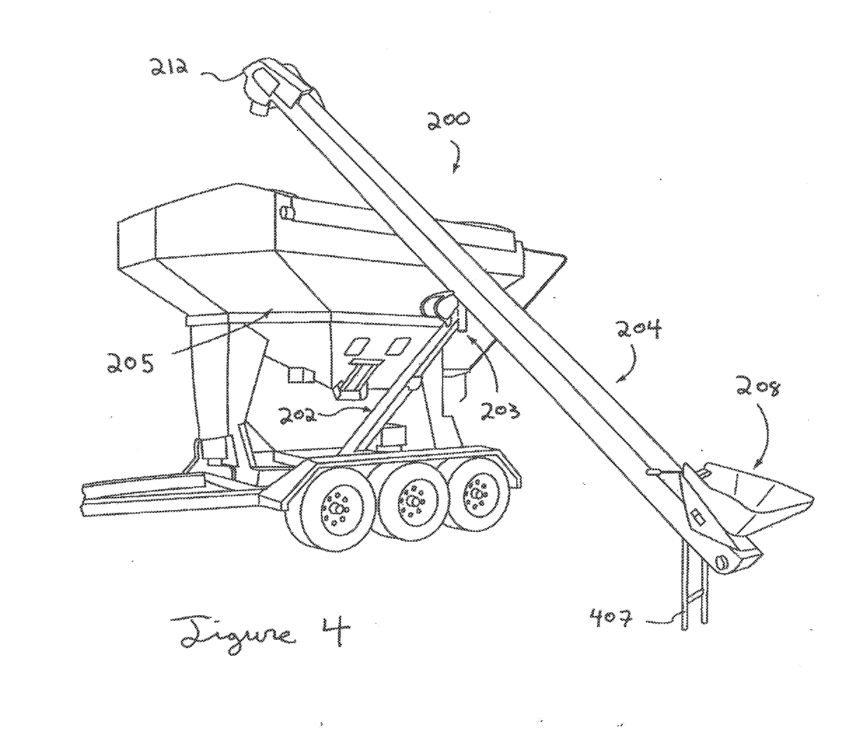

FIG. 4 illustrates the seed carrier 200 in the loading position. As shown, the conveyor 204 can be uncoupled from the support arm 202 at its base and rotated 180 degrees about pivot coupling 203 so that the conveyor hopper 208 is positioned at a convenient location away from the carrier while the discharge 212 of the conveyor 204 is located over the main hopper 205. A stand 407 is provided for holding the conveyor hopper 208 in place. The stand 407 may be integrated with the conveyor 204.

Accordingly, in the loading position, grain, seed or like can be feed into the conveyor hopper 208 to be moved to the discharge 212 for filling the main hopper 205.

When the seed carrier 200 is in the loading position, the automatic conveyor control system can regulate the amount of material being loaded into the main hopper 205 in a similar fashion. The weigh system measures the weight of the material loaded into the main hopper 205. When the weight of the material loaded into the main hopper 205 achieves a preset limit, the scale indicator 130 sends a signal to the multi-switch 110. The multi-switch 110 then turns off the conveyor 204 via the conveyor control valve 140. In an embodiment of the present invention, a user may turn the conveyor 204 back on using the operator control switch 150, and the conveyor 204 will load material into the main hopper 205 until the next preset limit is achieved.

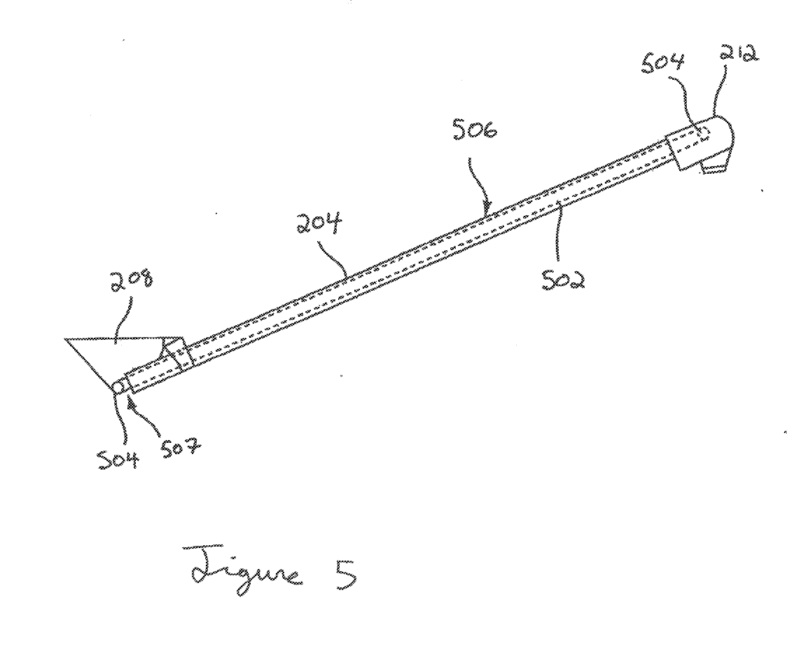

FIG. 5 illustrates a conveying device according to an embodiment of the present invention. The conveying device is a motor driven belt conveyor 104. The conveyor 104 comprises a belt 502 that winds about a pair of rollers 504. The rollers are positioned outside a tube section 506, a first roller being positioned in the discharge 112 and a second roller being positioned below the conveyor hopper 108. A motor (not shown) or other means for turning the rollers may be provided at either end of the conveyor. A void 507 exists below the rollers 504 to allow the belt 502 to travel on its return path.

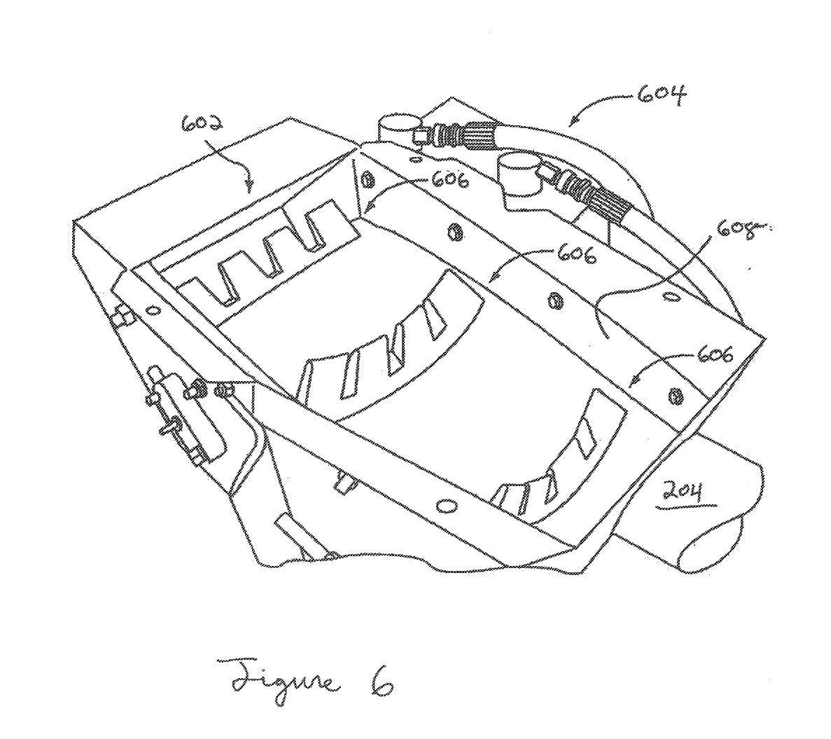

FIG. 6 is a view of a conveyor belt according to an embodiment of the present invention. The discharge end of a conveyor is shown where a conveyor belt wraps around a motor driven roller 602. The motor may be a hydraulic motor and therefore, hydraulic hoses 604 provide hydraulic fluid flow to and from the motor. Teeth 606 are provided to push grain or seed up the conveyor. As shown, the conveyor belt is cupped in the tube section but flattens out as it reaches the roller 602. Channeling members (seals) 608 are provided on each side of the belt to form a seal and prevent grain or seed from falling off the edges of the belt as the belt begins to conform to the tubular portion of the conveyor 104.

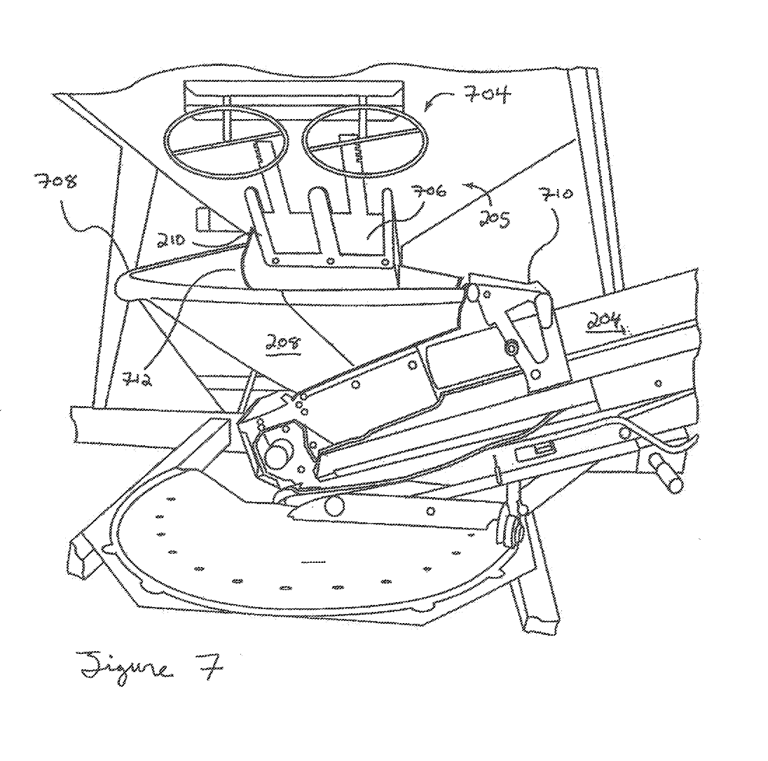

FIG. 7 is a side view of the hopper end of the conveyor 104. As shown, conveyor hopper 208 sits above in ingress to the conveyor 104. When coupled to the support arm 202, as shown, the conveyor hopper 208 is positioned below a discharge of the main hopper 210. The discharge 210 may be opened by conventional means. As showed, a wheel handle mechanism 704 is provided for opening the discharge doors 706.

The conveyor hopper 208 is preferably manufactured from light weight materials such as plastic, canvas, rubber or vinyl. As shown, the hopper 208 may include a mechanism for opening and closing the hopper 208. In this embodiment, a flexible coupling or hinge is provided at one end 708 of the hopper 208 and a mechanism 710 is provided at another end of the hopper 208 and is coupled with the conveyor 204, such that the hopper 208 may be made to have an appropriate fit with the discharge 210 of the main hopper 205. A flap 712 can be provided at the bottom of the discharge 110.

Thus, a number of preferred embodiments have been fully described above with reference to the drawing figures. Although the invention has been described based upon these preferred embodiments, it would be apparent to those of skill in the art that certain modifications, variations, and alternative constructions could be made to the described embodiments within the spirit and scope of the invention. For example, the conveyor controller could be built into the same processor as is used for a digital scale. A computerized method could be provided for controlling the conveyer.

1. A system for controlling the amount of material moved by a conveying device of a farm implement, the farm implement having a storage bin for storing material, a conveying device having an input at a first end and a discharge at a second end, said system comprising:
a weighing device configured to measure the weight of said bin and to output a signal representing said weight;
a controller electronically coupled with said weighing device and configured to receive said signal representing said weight and to transmit a disable signal when said weight reaches a preset weight; and
a conveyor control valve electronically coupled to said controller and configured to receive said disable signal from said controller and to disable said conveying device upon receiving said disable signal.

2. The system of claim 1, further comprising an input device configured to allow an operator to enter at least one weight limit and said preset weight is set to said at least one weight limit.

3. The system of claim 1, further comprising a user control switch configured to allow an operator to manually activate and disable said conveying device.

4. The system of claim 1, wherein said weighing device includes a scale display indicator that displays the weight of said storage bin and outputs an alarm when the weight of the material in the storage bin reaches a preset limit.

5. The system of claim 1, wherein said conveying device is a motor driven belt conveyor.

6. The system of claim 1, wherein said storage bin includes a discharge.

7. The system of claim 6, wherein said conveying device input is positioned to receive material from said storage bin discharge.

8. The system of claim 1, wherein said conveying device discharge is positioned over said storage bin.

9. The system of claim 1, wherein said conveyor control valve comprises a throttle actuator.

10. A method for controlling the amount of material output from a conveying device, comprising steps of:
storing material in a storage bin;
with a conveying device, conveying material into or from said storage bin;
with an electronic scale, monitoring the weight of said storage bin;
providing one or more preset weight limits;
sending a signal, with the electronic scale, representing the weight of said storage bin to a controller;
determining if said weight of said storage bin meets or exceeds said preset weight limit; and
with the controller, electronically controlling said conveyor to disable said conveyor when it is determined that said weight meets said preset weight limit.

11. The method of claim 10, further comprising steps of:
with an input device, entering at least one weight limit; and
setting said at least one weight limit as the one or more preset weight limits.

12. The method of claim 10, further comprising a step of providing a means for an operator to manually activate and disable said conveying device.

13. The method of claim 10, further comprising steps of:
displaying the weight of a storage bin; and
outputting an alarm signal when the weight of the material in the storage bin reaches a preset limit.

14. The method of claim 10, further comprising steps of:
sending the alarm signal to said controller; and
with the controller, disabling said conveying device upon receiving the alarm signal.

15. The method of claim 14, further comprising a step of discharging material from said storage bin.

16. The method of claim 10 further comprising a step of receiving the material discharged from said storage bin discharge at an input of said conveying device.

17. The method of claim 16 further comprising a step of discharging material from said conveying device into said storage bin.

18. The method of claim 10 further comprising a step of controlling said conveying device with a conveyor control valve electronically coupled to said controller and configured to receive a signal from said controller and disable said conveying device upon receiving the signal.
